(19) United States
(12) Patent Application Publication
(10) Pub. No.: US 2005/0149380 A1
(43) Pub. Date: Jul. 7, 2005

(54) Method of determining whether to develop products for potential customers

(76) Inventor: Parl C. Hummel, Manchester, MO (US)

Correspondence Address: THOMPSON COBURN, LLP, ONE US BANK PLAZA, SUITE 3500, ST LOUIS, MO, 63101, US

(21) Appl. No.: 10/753,889

(22) Filed: Jan. 7, 2004

(51) Int. Cl. G06F 17/60

(52) U.S. Cl. 705/10

(57) ABSTRACT

A method of determining whether to develop products, such as software products or hardware products, for potential customers, such as different types of helicopters. The method comprises: identifying a plurality of potential products; identifying a plurality of potential customers; determining for each of the potential products all possible implementation combinations in which at least n of the potential customers implement the product, where n is a positive whole number; determining the probability of each such combination; deciding, based upon the probability determinations, which of the potential products to develop; and developing the products so decided.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

Traditional product development efforts are isolated programs that focus little effort on reusing products (e.g., hardware or software) that are developed elsewhere within a contracting company. Reinventing a product for one customer (e.g., for one type of helicopter or one helicopter Program Management Office) that performs essentially the same function as an earlier product for a different use (e.g., a different type of helicopter or a different helicopter Program Management Office) is costly in terms of development, procurement, operation and support.

### SUMMARY OF THE INVENTION

Generally, an aspect of the present invention is a method of determining whether to develop products, such as software products or hardware products, for potential customers, such as different types of helicopters. The method comprises: identifying a plurality of potential products; identifying a plurality of potential customers; determining for each of the potential products all possible implementation combinations in which at least n of the potential customers implement the product, where n is a positive whole number; determining the probability of each such combination; deciding, based upon the probability determinations, which of the potential products to develop; and developing the products so decided.

Another aspect of the present invention is a method comprising: identifying a plurality of potential software products; identifying a plurality of potential software customers; determining for each of the potential software products all possible implementation combinations in which at least n of the potential software customers implement the software product, where n is a positive whole number; determining the probability of each such combination; deciding, based upon the probability determinations, which of the potential software products to develop; and developing the software products so decided.

Another aspect of the present invention is a method comprising: identifying a plurality of potential software products; identifying a plurality of potential software customers; determining, for each one of at least a plurality of the potential software products and for each one of at least a plurality of the potential software customers, the probability of the potential software customer implementing the potential software product; deciding, based upon the probability determinations, which of the potential software products to develop; and developing the software products so decided.

Another aspect of the present invention is a method comprising: identifying a plurality of potential products; identifying a plurality of potential customers; determining, for each one of at least a plurality of the potential products and for each one of at least a plurality of the potential customers, the probability of the potential customer implementing the potential product; deciding, based upon the probability determinations, which of the potential products to develop; and developing the products so decided.

Other features and advantages will be in part apparent and in part pointed out hereinafter.

### BRIEF DESCRIPTION OF THE DRAWINGS

FIG. 1 is a table, in accordance with a preferred method of the present invention, showing software application product prioritization for twenty-three software application products and five potential customers; and

FIG. 2 is a flow diagram of method steps of the preferred method of FIG. 1.

Corresponding reference characters indicate corresponding parts throughout the several views of the drawings.

### DETAILED DESCRIPTION OF THE PREFERRED EMBODIMENTS

A method of the present invention is a method of determining whether to develop products for potential customers. An example of a product is a software capability. An example of a potential customer may be a helicopter Program Management Office (“PMO”), such as an RAH-66 Comanche PMO, AH-64 Apache PMO, CH-47 Chinook PMO, UH-60 Black Hawk PMO, or unmanned aerial vehicles PMOs. Although the exemplary products addressed in connection with the present embodiment are software products, it is to be understood that other types of products may be employed without departing from the scope of the present invention. Also, although the exemplary customers addressed in connection with the present embodiment are helicopter PMOs, it is to be understood that other types of customers (e.g., users) may be employed without departing from the scope of this invention.

Development costs of a first product having a particular attribute (e.g., a particular system capability that supports its function or supports its compatibility with other systems) but developed for only a single user is often less than the development costs of a second product having the same attribute but developed for multiple users. If it is anticipated that only one user demands the attribute, then the first product should be developed to the exclusion of the second. If it is anticipated that more than one user demands the attribute, then development of the second product might be more economical. In the present example, the first product is a system capability for which a software application must be developed via a first helicopter PMO and the second product is a comparable system capability for which a comparable software application must be developed that can be used by the first helicopter PMO and by additional helicopter PMOs. Also in the present example, the first product costs less to develop than the second product. If the only potential market for the system capability is the first helicopter PMO, then the second product should not be developed. If the potential market for the system capability includes additional helicopter PMOs, then it is desirable to determine whether the probability of the potential market is sufficiently high to justify development of the second product instead of the first. Depending on anticipated development costs, it might be more economical to develop the second product (e.g., versatile software capable of being used by the different helicopter PMOs) than to develop custom software for each type of helicopter. It is understood that there is a premium to be paid for developing software that is reusable. The premium tends to be about an additional 50% of the cost of developing non-reusable software. This premium suggests that a software application must be reused at least once for a cost benefit to occur.

In a leader/follower relationship, an implementation of a capability involves two steps. First software for the capability is developed for the leader and then one or more followers reuse the software. The leader follower relationship is referred to as dependency. For a follower to realize a large cost avoidance when implementing a capability: (a) the capability must first become a requirement for the follower; (b) there must be a leader to perform the original development; (c) it must be possible to schedule the follower's implementation to follow the leader's; and (d) the affordability improvements achievable through reuse must be sufficient. In other words, for a follower to implement a capability it is to be requirable, affordable, and schedulable. The necessity for all three criteria to be met is referred to as conditional. The event that the leader will implement a capability is independent of the event that any other platform will implement the capability. The event that a follower will implement a capability is independent of the event that any other follower will implement the capability. This type of problem is conveniently analyzed using Bernoulli Statistics.

The event that the leader will implement a capability is independent of the event that any other platform will implement the capability. A set of all possible mutually exclusive outcomes of an experiment is called a sample space. And since there is only one leader per capability, there are only two points in the sample space: (1) the leader implements the capability; (2) the leader fails to implement the capability.

The implementation of a capability by a follower is assumed to be conditional on three things: becoming requirable, becoming affordable, and becoming schedulable. Thus, the event being sought is:
EF=Follower requires the capability and can afford it and can schedule it. Probabilities are assigned to each event. The probabilities may be determined by expert opinion or by some other suitable means. The probabilities for each event include:
P(FR)=probability that the follower requires the capability
P(FA)=probability that the follower can afford the capability
P(FS)=probability that the follower can schedule the capability
   The above three probabilities are conditional probabilities. The probability of the event EF is the product of the conditional probabilities:
   P(EF)=P(FR)*P(FA)*P(FS)
   P(EF) is also referred to herein as the probability of the potential customer (e.g., follower) implementing the potential product (e.g., software capability). P(FR) is also referred to herein as a requirability probability, P(FA) is also referred to herein as an affordability probability, and P(FS) is also referred to herein as an availability (or schedulability) probability).

A set of all possible mutually exclusive outcomes of an experiment is called a sample space. In order to use a sample space to solve problems, the probabilities of each of the points of the sample space are needed. Each point in the sample space is defined by dimensions that can assume the value “success” or “failure”. For example, if the experiment consists of three followers attempting to reuse a capability the uniform sample space is:
(a) followers #1, #2, and #3 all fail to implement the capability;
(b) follower #1 succeeds and followers #2 and #3 fail;
(c). follower #2 succeeds and follower #1 and #3 fail;
(d). follower #3 succeeds and follower #1 and #2 fail;
(e). followers #1 and #2 succeed and follower #3 fails;
(f). followers #1 and #3 succeed and follower #2 fails;
(g). followers #2 and #3 succeed and follower #1 fails;
(h). followers #1, #2, and #3 all succeed.
   Each combination (b)-(h) is referred to as an implementation combination. In order to use a sample space to solve problems, the probability of each implementation combination is needed. Again using the example of three followers attempting to reuse a capability, the probabilities associated with the following events may be computed:
   EF1=follower #1 requires the capability and can afford it and can schedule it
   EF2=follower #2 requires the capability and can afford it and can schedule it
   EF3=follower #3 requires the capability and can afford it and can schedule it
      The probabilities that each respective event will occur are:
      P(EF1)=P(FR1)*P(FA1)*P(FS1)
      P(EF2)=P(FR2)*P(FA2)*P(FS2)
      P(EF3)=P(FR3)*P(FA3)*P(FS3)
      The respective probabilities of the implementation combinations are:
      PF1=[1−P(EF1)]*[1−P(EF2)]*[1−P(EF3)]
      PF2=[P(EF1)]*[1−P(EF2)]*[1−P(EF3)]
      PF3=[1−P(EF1)]*[P(EF2)]*[1−P(EF3)]
      PF4=[1−P(EF1)]*[1−P(EF2)]*[P(EF3)]
      PF5=[P(EF1)]*[P(EF2)]*[1−P(EF3)]
      PF6=[P(EF1)]*[1−P(EF2)]*[P(EF3)]
      PF7=[1−P(EF1)]*[P(EF2)]*[P(EF3)]
      PF8=[P(EF1)]*[P(EF2)]*[P(EF3)]
      As mentioned earlier, in a reuse example the process for implementation of a capability involves two steps. First the leader successfully develops the software for the capability and then one or more followers reuse the software. As far as the followers are concerned, the criteria for reuse is one of more followers must reuse the software. Thus, if P(B:A) is the probability of the event that one or more platforms reuse the software (event B) given that the leader has developed the software (event A), then:
      P(B:A)=PF2+PF3+PF4+PF5+PF6+PF7+PF8
      It is also possible to write P(B:A) using the theorem of normalcy, i.e., the sum of the probabilities of the points in the event space add up to unity. Saying that one or more platforms succeed in reusing the software is the same as saying that none of the platforms fail to reuse the software, i.e.
      P(B:A)=1−PF1
      Success is defined as development by the leader and reuse by the follower, i.e.,
      P(A,B)=P(A)*P(B:A)=P(EL)*(PF2+PF3+PF4+PF5+PF6+PF7+PF8)

The expected value of a random variable is the weighted sum of all the values of the variable, each value weighted by its probability of occurrence. The average number of instances of software reused and the likelihood that it will occur gives a measure of the value of reuse for any given capability. Consider the implementation combinations below.
(a) followers #1, #2, and #3 all fail to implement the capability
(b) follower #1 succeeds and followers #2 and #3 fail
(c) follower #2 succeeds and follower #1 and #3 fail
(d) follower #3 succeeds and follower #1 and #2 fail
(e) followers #1 and #2 succeed and follower #3 fails
(f) followers #1 and #3 succeed and follower #2 fails
(g) followers #2 and #3 succeed and follower #1 fails
(h) followers #1, #2, and #3 all succeed
   As indicted above, the respective probabilities of the implementation combinations are:
   PF1=[1−P(EF1)]*[1−P(EF2)]*[1−P(EF3)]
   PF2=[P(EF1)]*[1−P(EF2)]*[1−P(EF3)]
   PF3=[1−P(EF1)]*[P(EF2)]*[1−P(EF3)]
   PF4=[1−P(EF1)]*[1−P(EF2)]*[P(EF3)]
   PF5=[P(EF1)]*[P(EF2)]*[1−P(EF3)]
   PF6=[P(EF1)]*[1−P(EF2)]*[P(EF3)]
   PF7=[1−P(EF1)]*[P(EF2)]*[P(EF3)]
   PF8=[P(EF1)]*[P(EF2)]*[P(EF3)]
   The number of successes for the i^{th} point in the sample space is represented as NSi The values that NSi may assume are 0, 1, 2, or 3. Thus, for each point in the sample space the corresponding values of NS are
   NS1=0
   NS2=1
   NS3=1
   NS4=1
   NS5=2
   NS6=2
   NS7=2
   NS8=3
      The Expected Value of the number of reuse instances is then given by the equation:
      E(NS)=NS1*PF1+NS2*PF2+NS3*PF3+NS4*PF4+NS5*PF5+NS6*PF6+NS7*PF7+NS8*PF8.
      The expected value of the number of reuse instances can be determined for each product (e.g., for each software capability). A product developer may rank the products based on the E(N) for each product and then develop those products whose E(N) is greater than or equal to a threshold value.

A second metric to break ties in E(N) might sometimes be desirable. It is believed that there is a premium to be paid for developing software that is reusable. It is believed that such premium tends to be about an additional 50% of the cost of developing non-reusable software. This premium suggests that a software application must be reused at least once for a cost benefit to occur. A measure of the probability that one or more platforms will successfully reuse the mission software, P(N≧1), may be calculated to serve as a secondary metric for ranking the products.

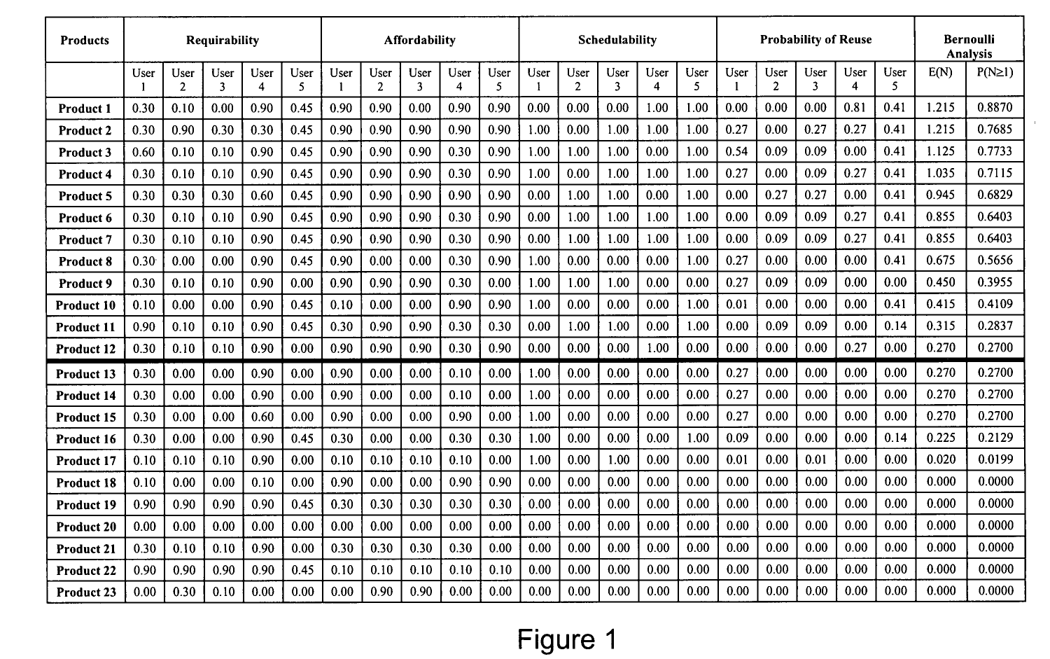

FIG. 1 is a table showing software product prioritization for twenty-three products (e.g., software products) for five potential customers. Preferably, the five potential customers are five different types of helicopters. Under the heading “Requirability” are requirability probabilities. Each requirability probability in the table of FIG. 1 is associated with one of the twenty three products and one of the five potential customers. A requirability probability is the probability that a potential customer requires a potential product. Preferably, each requirability probability is determined by expert analysis (e.g., expert opinion). Under the heading “Affordability” are affordability probabilities. Each affordability probability in the table of FIG. 1 is associated with one of the twenty three products and one of the five potential customers. An affordability probability is the probability that a potential customer is willing to pay for the potential product. Preferably, each affordability probability is determined by expert analysis (e.g., expert opinion). Under the heading “Availability” are availability probabilities or schedulability probabilities. Each availability probability in the table of FIG. 1 is associated with one of the twenty three products and one of the five potential customers. An availability probability is the probability that a potential product is available to (or schedulable for) the potential user. Preferably, each availability probability is determined by expert analysis (e.g., expert opinion).

Under the heading “Probability of Reuse” are reuse probabilities. A reuse probability (or more broadly referred to as an implementation probability) is the probability that a potential customer will implement a product. In the present example, the implementation probabilities are reuse probabilities, i.e., the probability that a follower will implement a product to be developed for a leader. However, it is to be understood that the invention is not limited to reuses. If a reuse situation is not involved, then the availability does not involve schedulability after a leader. The implementation probability for a customer and a product is the mathematical product of the requirability, affordability and availability probabilities of the customer and one of the products. For example, the probability that User 1 will implement Product 2 is 0.27, and is calculated by multiplying together the corresponding requirability probability (0.3), affordability probability (0.9), and availability probability (1.0). Likewise, the probability that User 5 will implement Product 3 is 0.41, and is calculated by taking the product of the corresponding requirability, affordability and availability probabilities (i.e., (0.45)(0.9)(1.0)=0.41). In FIG. 1, two columns are under the heading “Bernoulli Analysis.” The first column include the E(N) for each product. The second column includes the probabilities of at least one reuse P(N≧1). In the table of FIG. 1, the products are ranked by E(N) and P(N≧1) values. The dark solid horizontal line between Products 12 and 13 represents a threshold value. Based on the threshold value, it may be determined that Products 1-12 should be developed and Products 13-23 should not be developed.

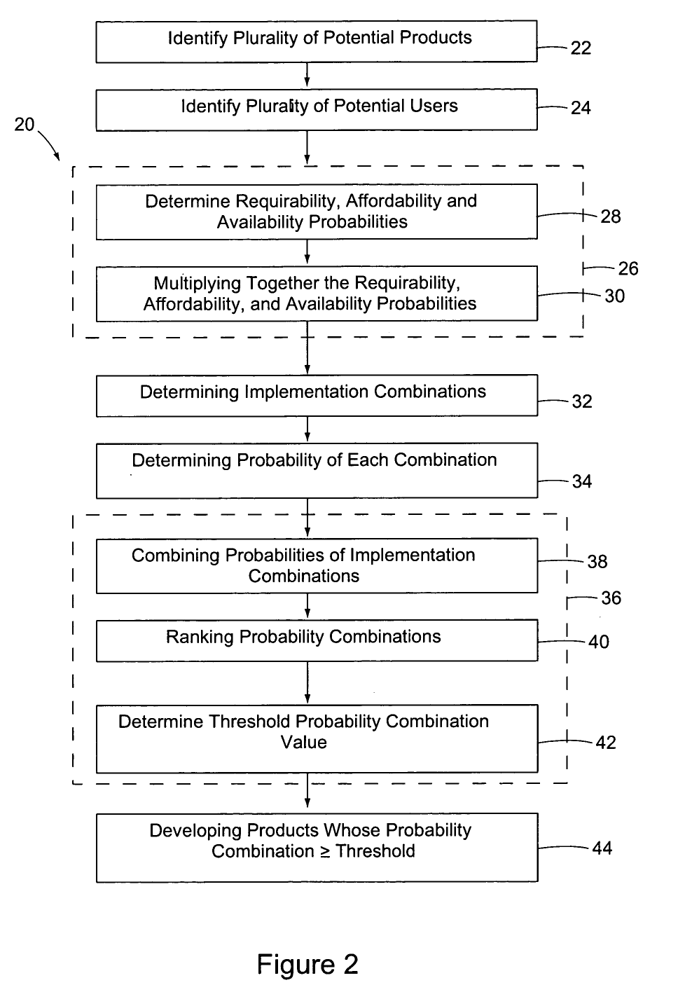

FIG. 2 is a flow diagram, generally indicated at 20, of a preferred method of the present invention for determining whether to develop products, such as software products or hardware products, for potential customers, such as different types of helicopters. A plurality of potential products are identified at box 22. This identification of potential products corresponds to the column under the heading “Products” in FIG. 1. A plurality of potential customers are identified at box 24. The next step, represented by box 26, is the step of determining, for each one of at least a plurality of the potential products and for each one of at least a plurality of the potential customers, the probability of the potential customer implementing the potential product. As discussed above these probabilities are P(EF). The probability (P(EF)) of the potential customer implementing the potential product comprises determining the requirability, affordability and availability probabilities for the product and customer (represented by box 28) and multiplying together these probabilities (represented by box 30). Preferably, these probabilities are determined by expert analysis. The implementation combinations (discussed in greater detail above) for each product are determined at box 32 and the probabilities of the implementation combinations P(F) are determined at box 34. The next step, represented by box 36, is the step of deciding, based upon probability determinations, which of the potential products to develop. Preferably, the step of deciding which of the potential products to develop comprises combining the probabilities of the implementation combinations P(F) for each product (represented by box 38), ranking the probability combinations (represented by box 40), and determining a threshold probability combination value (represented by box 42). Preferably, the step of combining the probabilities of the implementation combinations comprises determining expected value numbers E(N) for each product and/or determining the probability of at least one reuse P(N≧1) for each product. The next step, represented by box 44, is the step of developing the products decided by the step of box 36. Preferably, the step of developing the products comprises developing each product whose corresponding probability combination is equal to or greater than the threshold probability combination value.

Although the customers have been described as helicopters, it is to be understood that the term customers is not limited to helicopters. Also, it is to be understood that the term products is not limited to software products.

In view of the above, it will be seen that the several objects of the invention are achieved and other advantageous results attained.

As various changes could be made in the above methods without departing from the scope of the invention, it is intended that all matter contained in the above description or shown in the accompanying drawings shall be interpreted as illustrative and not in a limiting sense. The invention therefore shall be limited solely by the scope of the claims set forth below.

1. A method of determining whether to develop products, such as software products or hardware products, for potential customers, such as different types of helicopters, comprising:
identifying a plurality of potential products;
identifying a plurality of potential customers;
determining for each of the potential products all possible implementation combinations in which at least n of the potential customers implement the product, where n is a positive whole number;
determining the probability of each such combination;
deciding, based upon the probability determinations, which of the potential products to develop;
developing the products so decided.

2. A method as set forth in claim 1 wherein the step of identifying a plurality of potential products comprises identifying a plurality of potential software products or potential hardware products.

3. A method as set forth in claim 1 wherein the step of identifying a plurality of potential customers comprises identifying a plurality of different types of helicopters.

4. A method as set forth in claim 1 wherein the step of deciding which of the potential products to develop comprises:
combining, for each potential product, the probabilities of the implementation combinations for the potential product such that each potential product has a corresponding probability combination; and
ranking the probability combinations.

5. A method as set forth in claim 4 wherein:
the step of deciding which of the potential products to develop further comprises determining a threshold probability combination value; and
the step of developing the product comprises developing each product whose corresponding probability combination is equal to or greater than the threshold probability combination value.

6. A method as set forth in claim 4 wherein the step of combining, for each potential product, the probabilities of the implementation combinations for the potential product comprises:
adding together the probabilities of the implementation combinations for the potential product.

7. A method as set forth in claim 1 further comprising:
determining, for each one of at least a plurality of the potential products and for each one of at least a plurality of the potential customers, the probability of the potential customer implementing the potential product.

8. A method as set forth in claim 7 wherein the step of determining the probability of the potential customer implementing the potential product comprises:
determining a requirability probability, the requirability probability being the probability that the potential customer requires the potential product;
determining an affordability probability, the affordability probability being the probability that the potential customer is willing to pay for the potential product;
determining an availability probability, the availability probability being the probability that the potential product is available to the potential user.

9. A method as set forth in claim 8 wherein the step of determining the probability of the potential customer implementing the potential product comprises multiplying together the requirability probability, the affordability probability, and the availability probability.

10. A method as set forth in claim 1 further comprising:
determining, for each one of the potential products and for each one of the potential customers, the probability of the potential customer implementing the potential product.

11. A method as set forth in claim 10 wherein the step of determining the probability of the potential customer implementing the potential product comprises:
determining a requirability probability, the requirability probability being the probability that the potential customer requires the potential product;
determining an affordability probability, the affordability probability being the probability that the potential customer is willing to pay for the potential product;
determining an availability probability, the availability probability being the probability that the potential product is available to the potential customer.

12. A method as set forth in claim 10 wherein the potential products are potential software products.

13. A method comprising:
identifying a plurality of potential software products;
identifying a plurality of potential software customers;
determining for each of the potential software products all possible implementation combinations in which at least n of the potential software customers implements the software product, where n is a positive whole number;
determining the probability of each such combination;
deciding, based upon the probability determinations, which of the potential software products to develop;
developing the software products so decided.

14. A method as set forth in claim 13 wherein the step of deciding which of the potential software products to develop comprises:
combining, for each potential software product, the probabilities of the implementation combinations for the potential software product such that each potential software product has a corresponding probability combination; and
ranking the probability combinations.

15. A method as set forth in claim 14 wherein:
the step of deciding which of the potential software products to develop further comprises determining a threshold probability combination value; and
the step of developing the software products comprises developing each software product whose corresponding probability combination is equal to or greater than the threshold probability combination value.

16. A method as set forth in claim 14 wherein the step of combining, for each potential software product, the probabilities of the implementation combinations for the potential software product comprises:
adding together the probabilities of the implementation combinations for the potential software product.

17. A method as set forth in claim 13 further comprising:
determining, for each one of at least a plurality of the potential software products and for each one of at least a plurality of the potential software customers, the probability of the potential software customer implementing the potential software product.

18. A method as set forth in claim 17 wherein the step of determining the probability of the potential software customer implementing the potential software product comprises:
determining a requirability probability, the requirability probability being the probability that the potential software customer requires the potential software product;
determining an affordability probability, the affordability probability being the probability that the potential software customer is willing to pay for the potential software product;
determining an availability probability, the availability probability being the probability that the potential software product is available to the potential software user.

19. A method as set forth in claim 18 wherein the step of determining the probability of the potential software customer implementing the potential software product comprises multiplying together the requirability probability, the affordability probability, and the availability probability.

20. A method as set forth in claim 13 further comprising:
determining, for each one of the potential software products and for each one of the potential software customers, the probability of the potential software customer implementing the potential software product.

21. A method as set forth in claim 20 wherein the step of determining the probability of the potential software customer implementing the potential software product comprises:
determining a requirability probability, the requirability probability being the probability that the potential software customer requires the potential software product;
determining an affordability probability, the affordability probability being the probability that the potential software customer is willing to pay for the potential software product;
determining an availability probability, the availability probability being the probability that the potential software product is available to the potential software user.

22. A method comprising:
identifying a plurality of potential software products;
identifying a plurality of potential software customers;
determining, for each one of at least a plurality of the potential software products and for each one of at least a plurality of the potential software customers, the probability of the potential software customer implementing the potential software product;
deciding, based upon the probability determinations, which of the potential software products to develop;
developing the software products so decided.

23. A method as set forth in claim 22 wherein the step of determining the probability of the potential software customer implementing the potential software product comprises:
determining a requirability probability, the requirability probability being the probability that the potential software customer requires the potential software product;
determining an affordability probability, the affordability probability being the probability that the potential software customer is willing to pay for the potential software product;
determining an availability probability, the availability probability being the probability that the potential software product is available to the potential software user.

24. A method as set forth in claim 23 wherein the step of determining the probability of the potential software customer implementing the potential software product comprises multiplying together the requirability probability, the affordability probability, and the availability probability.

25. A method comprising:
identifying a plurality of potential products;
identifying a plurality of potential customers;
determining, for each one of at least a plurality of the potential products and for each one of at least a plurality of the potential customers, the probability of the potential customer implementing the potential product;
deciding, based upon the probability determinations, which of the potential products to develop;
developing the products so decided.

26. A method as set forth in claim 25 wherein the step of determining the probability of the potential customer implementing the potential product comprises:
determining a requirability probability, the requirability probability being the probability that the potential customer requires the potential product;
determining an affordability probability, the affordability probability being the probability that the potential customer is willing to pay for the potential product;
determining an availability probability, the availability probability being the probability that the potential product is available to the potential user.

27. A method as set forth in claim 26 wherein the step of determining the probability of the potential customer implementing the potential product comprises multiplying together the requirability probability, the affordability probability, and the availability probability.

28. A method as set forth in claim 25 wherein the step of determining, for each one of at least a plurality of the potential products and for each one of at least a plurality of the potential customers, the probability of the potential customer implementing the potential product comprises:
determining, for each one of the potential products and for each one of the potential customers, the probability of the potential customer implementing the potential product.

29. A method as set forth in claim 28 wherein the step of determining, for each one of the potential products and for each one of the potential customers, the probability of the potential customer implementing the potential product comprises:
determining a requirability probability, the requirability probability being the probability that the potential customer requires the potential product;
determining an affordability probability, the affordability probability being the probability that the potential customer is willing to pay for the potential product;
determining an availability probability, the availability probability being the probability that the potential product is available to the potential user.
